(19) United States
(12) Patent Application Publication
(10) Pub. No.: US 2024/0309734 A1
(43) Pub. Date: Sep. 19, 2024

(54) DOWNHOLE NON-THERMAL RADIOISOTOPE POWER SOURCE FOR OPERATION IN A WELLBORE

(71) Applicant: Halliburton Energy Services, Inc., Houston, TX (US)

(72) Inventors: Stephen Michael Greci, Carrollton, TX (US); Gordon McLeary, Carrollton, TX (US); Ryan W. McChesney, Carrollton, TX (US)

(21) Appl. No.: 18/183,497

(22) Filed: Mar. 14, 2023

(51) Int. Cl. E21B 41/00; E21B 49/00; G21H 1/06

(52) U.S. Cl. CPC E21B 41/0085; E21B 49/00; G21H 1/06

(57) ABSTRACT

Some implementations include a downhole power source to be positioned in a wellbore to supply electrical power to an electrical device in the wellbore, the downhole power source comprising a radioisotope source to be positioned downhole in the wellbore to emit radiation. One or more semiconductor layers to be positioned downhole in the wellbore may be configured to capture the emitted radiation from the radioisotope source and to may be configured to generate the electrical power based on the captured radiation.

### BACKGROUND

Providing downhole electric power to tools and equipment is typically accomplished by running cables from the surface into a well, using a downhole turbine for power generation, or by using batteries in a tool with a finite life and charge. Conventional approaches may be expensive. These conventional approaches may also limit an operating window of a completion, particularly in the case of batteries and turbine generators that require constant production flow to generate power.

### BRIEF DESCRIPTION OF THE DRAWINGS

Embodiments of the disclosure may be better understood by referencing the accompanying drawings.

FIG. 1 depicts an example non-thermal radio-voltaic downhole power source and an electrical device to be powered by the non-thermal radio-voltaic downhole power source, according to some embodiments.

FIG. 2 depicts an example well completion system, according to some embodiments.

FIG. 3 depicts an example cross-section of a mandrel housing the non-thermal radio-voltaic downhole power source, according to some embodiments.

FIG. 4 depicts a flowchart of example operations for powering downhole electrical devices, according to some embodiments.

### DESCRIPTION

The description that follows includes example systems, methods, techniques, and program flows that embody aspects of the disclosure. However, it is understood that this disclosure may be practiced without these specific details. In other instances, well- known instruction instances, protocols, structures, and techniques have not been shown in detail in order not to obfuscate the description.

Example embodiments may include a non-thermal radio-voltaic power source positioned downhole in a wellbore to generate power independent of thermal conditions in the wellbore. Non-thermal radio-voltaic power sources may be capable of generating power for many years and even decades in downhole conditions due to the solid-state nature of their construction. In contrast, a traditional battery in such conditions may have a life measured in weeks or months. Additionally, non-thermal radio-voltaic power sources may provide power to any type of device downhole (such as sensors and other downhole tools) without external cables or other moving parts. Accordingly, example embodiments may provide power to downhole devices to allow such devices to continue to operate even after a well is shut in and/or long after a traditional battery positioned downhole has been depleted. Issues stemming from battery degradation in high-temperature applications may also be avoided.

### Example Downhole Non-thermal Radio-Voltaic Power Source

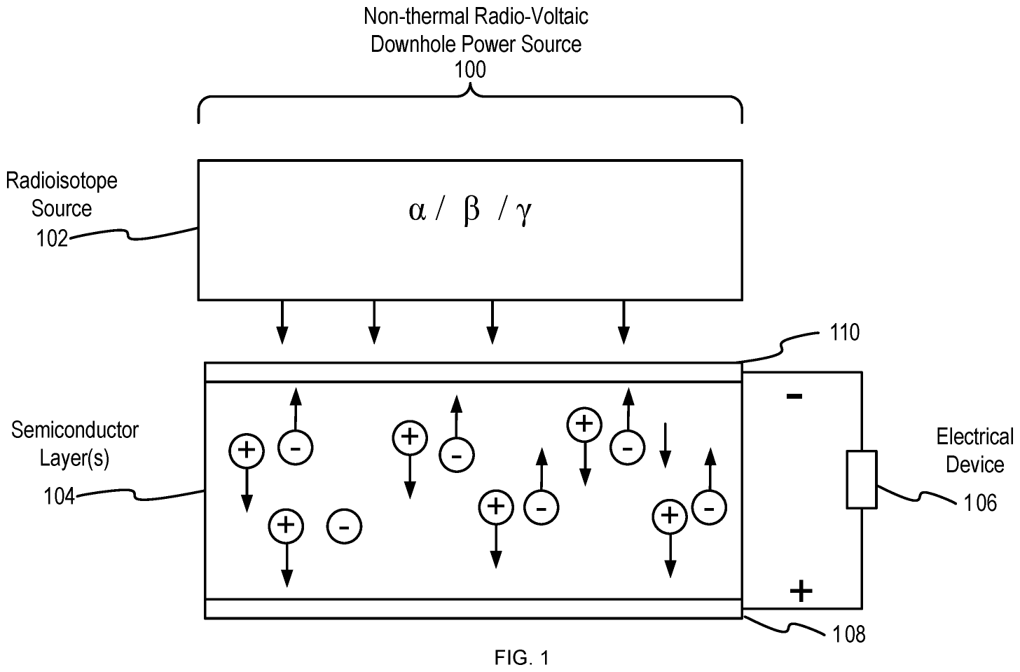

An example downhole non-thermal radio-voltaic power source is now described. FIG. 1 depicts an example non-thermal radio-voltaic downhole power source and an electrical device to be powered by the non-thermal radio-voltaic downhole power source, according to some embodiments. In FIG. 1, a non-thermal radio-voltaic downhole power source 100 is electrically coupled to an electrical device 106. The non-thermal radio-voltaic downhole power source 100 may comprise a radioisotope source 102 and one or more semiconductor layers 104.

In some embodiments, the radioisotope source 102 may comprise tritium, but a number of different radioisotopes may be used as the radioisotope source 102. The radioisotope source 102 may be in the form of a solid section of foil, although other configurations are possible. The radioisotope source 102 may emit alpha, beta, and/or gamma particles as radiation. The radioisotope source 102 and the semiconductor layers 104 may be configured to be placed within close proximity of one another. The semiconductor layers 104 may be configured to capture the particles emitted as radiation from the radioisotope source 102. The non-thermal radio-voltaic downhole power source 100 may produce electrical energy by converting the alpha, beta and/or gamma radiation emitted from the radioisotope source 102 and captured by the semiconductor layers 104. In some embodiments, the semiconductor layers 104 may be part of a multilayer solid-state semiconductor structure comprising one or more P-N junctions and electric fields between layers. The semiconductor layers 104 may comprise a P-type semiconductor, an N-type semiconductor, or a combination of one or more layered P-type and N-type semiconductors. In some embodiments, the semiconductor layers 104 may comprise various thicknesses to capture the different types of particles emitted by the radioisotope source 102. In some implementations, the semiconductor layers 104 may comprise one or more thin layers of silicon, diamond, or other materials that have a high energy conversion efficiency and that may withstand the radiation emitted by the radioisotope source 102.

Rather than using a thermal differential across the semiconductor layers 104 to generate electricity, the non-thermal radio-voltaic downhole power source 100 utilizes the radiated particles from the radioisotope source 102. Some of the particles emitted by the radioisotope source 102 (for example, the beta particles) may be captured by the semiconductor layers 104. Kinetic energy from the particles may be converted into electrical energy by the semiconductor layers 104 at a p-n junction diode separated by a depletion region. When a radiated particle enters the semiconductor layers 104, it may deposit its energy and create electron-hole pairs separated by an electric field. The electrons and holes then flow in opposite directions, creating a current that may be used to power an external circuit. The holes may collect on a positive side 108 of the semiconductor layers 104 while the electrons travel to a negative side 110 due to built-in potential at the p-n junction between the P-type and N-type layers. The electrons may travel through a circuit coupled with an electrical device 106 to rejoin their respective holes, thus providing power to the electrical device 106. The non-thermal radio-voltaic downhole power source 100 may be utilized for low power applications at, for example, a milliwatt or microwatt scale. In some embodiments, multiple non-thermal radio-voltaic downhole power sources 100 may be combined in series to provide a larger power output.

The electrical device 206 may be any type of downhole device using electrical power. For example, the electrical device 106 may be one or more micro-controllers, sensors, or motors depending on their power requirements. In other embodiments, the electrical device 106 may be a power storage device (e.g., a battery, a capacitor, a solenoid, etc.). In some implementations, the radioisotope source 102 may be configured to power other components for use in downhole tools as well as charge capacitors, batteries, or other downhole power storage devices. In some implementations, the downhole power storage system may be used in conjunction with the non-thermal radio-voltaic downhole power source 100 to power an electronic component such as a sensor for a limited amount of time. In some embodiments, the radioisotope source 102 and semiconductor layers 104 may be installed within the electrical device 106.

### Example System

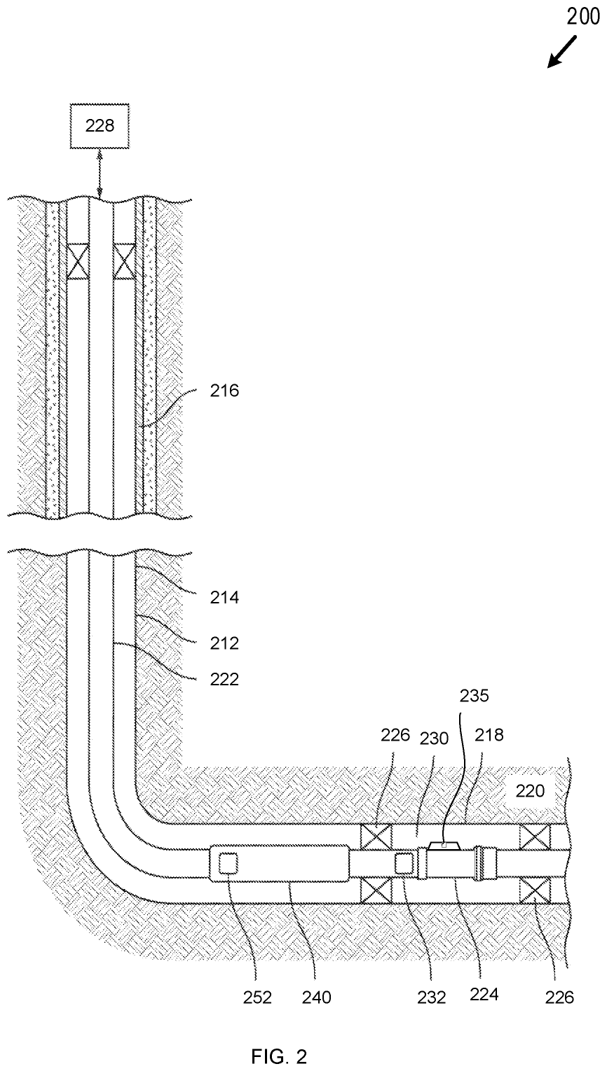

Example downhole non-thermal radio-voltaic power sources may be used in any downhole system/application (e.g., production, completion, drilling, etc.). An example well completion system utilizing the non-thermal radio-voltaic downhole power source from FIG. 1 is now described. FIG. 2 depicts an example well completion system, according to some embodiments. A well completion system 200 may comprise a wellbore 212 which intersects a subsurface formation 220. The wellbore 212 may include a vertical section 214 (which is at least partially cemented with a casing string 216) and a horizontal section 218. The horizontal section 218 may be an open-hole section of the wellbore 212. Other wellbore configurations may also be suitable.

Positioned within the wellbore 212 and extending from the surface is a tubing string 222 which provides a conduit for formation fluids to travel from the subsurface formation 220 to the surface and for stimulation fluids to travel from the surface to the subsurface formation 220. The tubing string 222 may include a production section 224 between one or more packers 226. The production section 224 may include a mandrel 235. In some implementations, the mandrel 235 may include the non-thermal radio-voltaic downhole power source 100 from FIG. 1.

The non-thermal radio-voltaic downhole power source 100 positioned in the mandrel 235 may be configured to supply power to one or more downhole devices similar to the electrical device 106 of FIG. 1. The downhole devices may be one or more of sensors, micro-controllers, motors, power storage devices, etc. While described as being positioned in the mandrel 235, the downhole devices being powered by a non-thermal radio-voltaic downhole power source may be positioned at any location in the wellbore 212.

The production section 224 may comprise multiple sections of pipe, including, for example, a sand screen section. The one or more packers 226 may provide a fluid seal between the tubing string 222 and the wellbore 212, thereby defining one or more production intervals 230. The production section 224 may comprise one or more valves 232 (e.g., interval control valves) configured to control fluid inflow and outflow to and from the production section 224. In some embodiments, the tubing string 222 may include a power generation source 240 comprising a power generation source of a larger power output than the non-thermal radio-voltaic downhole power source 100 to provide power to various downhole electronic components, including but not limited to pumps, sensors, actuators, valves, sleeves, baffles, etc.

For example, the power generation source 240 may include a processor and a turbine generator configured to convert flow fluid through the turbine into electrical power. The power generation source 240 may also include a downhole power storage device (e.g., a battery) with a suitable capacity to supply power to various downhole electronic components during initial completion and stimulation operations when there is insufficient fluid flow to generate enough power from the turbine generator. The downhole power storage device may also supply power to the downhole electronic components in conjunction with the turbine generator. Although FIG. 2 depicts the power generation source 240 as positioned in a zone that is not being produced, it should be understood that the power generation source 240 may be positioned anywhere along the wellbore 212, including proximate the production section 224.

In some embodiments, the power generation source 240 may include a telemetry device 252 that may receive data provided by various sensors located in the wellbore 212 and may transmit the data to a surface control unit 228. Data may also be provided by the surface control unit 228, received by the telemetry device 252 via a wired connection from the surface, via acoustic signals, or via other communication mediums. The telemetry device 252 may additionally transmit signals to the various electronic devices located in the wellbore 112 to perform functions, such as actuating one or more valves. The surface control unit 228 may include a computer system for processing and storing the measurements gathered by one or more sensors located in the wellbore 212. Among other things, the computer system may include a non-transitory computer-readable medium (e.g., a hard-disk drive and/or memory) capable of executing instructions to perform such tasks. In addition to collecting and processing measurements, the computer system may be capable of controlling completion, stimulation, and production operations including but not limited to as installation of the packers 226, acidizing, gravel packing, or hydraulic fracturing.

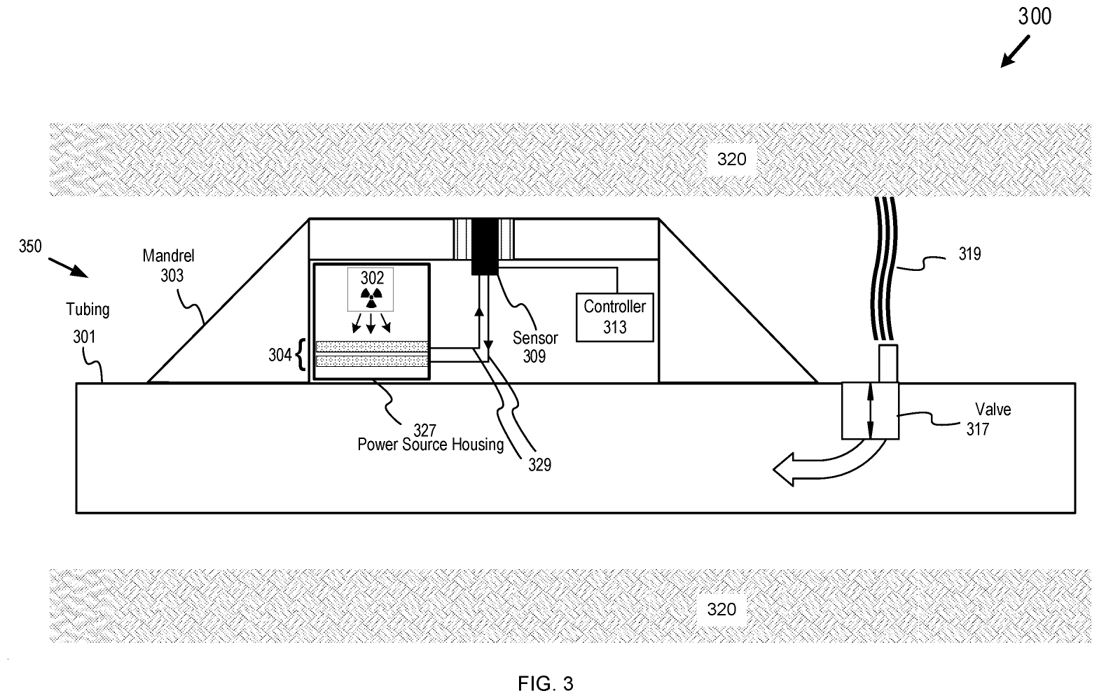

A more detailed description of an example of the mandrel 235 from FIG. 2 is now described. FIG. 3 depicts an example cross-section of a mandrel housing the non-thermal radio-voltaic downhole power source, according to some embodiments. A mandrel 303 may be disposed along a tubing 301. The tubing 301 is positioned in a wellbore 350 that is formed in a subsurface formation 320. While depicted as a compartment closed off from the tubing 301, in some embodiments the mandrel 303 may be open to an interior of the tubing 301. Other positions and configurations may be possible. The mandrel 303 may be similar to the mandrel 235 from FIG. 2, and the mandrel 303 may comprise a power source housing 327 within. The power source housing 327 may house a radioisotope source 302 and one or more semiconductor layers 304. In some embodiments, the radioisotope source 302 and semiconductor layers 304 may be similar to the radioisotope source 102 and semiconductor layers 104 described in the description of FIG. 1. The power source housing 327 may be a pressurized chamber set to the atmospheric pressure at the surface and isolated from a formation fluid 319 flowing from the subsurface formation 320. In some embodiments, the power source housing 327 may be comprised of metal or ceramic to prevent the escape of some radioactive particles, but other configurations may be possible.

Similar to the non-thermal radio-voltaic downhole power source 100 of FIG. 1, the radioisotope source 302 and semiconductor layers 304 may be configured to generate constant, low-output power. The power generated within the power source housing 327 may be routed via an electrical circuit 329 to a sensor 309. In some embodiments, a transformer (not depicted) may be disposed along the electrical circuit 329. The sensor 309 may be similar to the electrical device 106 described in the description of FIG. 1, although other devices may be used. The sensor 309 may be coupled to a controller 313 which may comprise a processor. In some embodiments, the controller 313 may also be intermittently powered via the radioisotope source 302 and semiconductor layers 304.

The sensor 309 may make measurements of the formation fluid 319. The controller 313 may be configured to receive these measurements of the formation fluid 319 from the sensor 309 at certain time intervals. In some embodiments, the controller 313 may control downhole operations based on these measurements, communicate these measurements to other devices (either downhole or at the surface), etc.

For example, the controller 313 may be configured to initiate operation of other power sources downhole based on the measurements by the sensor 309. For instance, the controller 313 may initiate activation of a power source that generates more power (as compared to the radioisotope source 302 and semiconductor layers 304) to supply power to devices that may require more power than may be provided by the radioisotope source 302 and semiconductor layers 304. For example, the larger power source may be a turbine generator, a limited duration battery, etc. to provide power to equipment in the well completion system 200 such as different types of flow control devices (e.g., a valve 317).

For example, the sensor 309 may detect a change in fluid properties of the formation fluid 319—thus inducing an action at the valve 317. In an example scenario, a zone of the subsurface formation 220 may be shut-in due to a suspected high water cut. During a wake phase, the sensor 309 may detect that the formation fluid 319 comprises a higher concentration of hydrocarbons than prior measurements. The hydrocarbon concentration may exceed a property threshold identified by the controller 313. Based on the measurement, the valve 317 may be actuated into an open position to allow fluid flow to the surface based on the measurement obtained during the wake phase of the sensor 309. In other embodiments, the valve 317 may be configured to open once a threshold value in one or more of the properties of the formation fluid 319 has been met.

The larger capacity power generation source may be powered on intermittently via a separate downhole power storage device or via a motor to induce an initial fluid flow through the device (for example, through a turbine generator which may use fluid flow to generate power). Once the larger capacity power generation source has been temporarily activated to supply power to a broader completions or production system in the wellbore 212, the valve 317 may be opened to allow the formation fluid 319 to enter the tubing 301.

In some embodiments, if a formation property or other parameter detected by the sensor 309 during a wake phase changes beyond a set property threshold, the controller 313 may be configured to autonomously transmit data. For example, the controller 313 transmits a signal to the surface indicating that a property threshold of a property of the formation fluid 319 has been met. Alternatively, the controller 313 may initiate a command during a wake phase to a larger capacity power generation source located within the wellbore 212, which may be similar to the power generation source 240 of FIG. 2. In some embodiments, the controller 313 may be electronically coupled to the larger capacity power generation source. The power generation source 240 may comprise components to generate a much larger power output than the radioisotope source 302, and the command sent by the controller 313 may instruct the power generation source 240 to activate.

In other embodiments, power may be routed to a downhole power storage device (not depicted) such as a capacitor. The radioisotope source 302 and semiconductor layers 304 may output power to the downhole storage device. The downhole power storage device may be coupled to the controller 313, and the controller 313 may be configured to store the electrical power in the downhole power storage device. The controller 313 may additionally be configured to control the power storage device such that the power storage device is to supply electrical power to the electrical device in response to a level of the electrical power stored in the downhole power storage device exceeding a threshold of power to enable operation of the sensor 309.

In some embodiments, the downhole storage device may supply power to the sensor 309 at set intervals or upon user command received via the controller 313. Such a configuration may enable the sensor 309 to sense environmental changes for a limited time before becoming dormant once again. This may be referred to as a wake/sleep cycle. During the wake phase, the sensor 309 may obtain measurements of the formation fluid 319. In other embodiments, the sensor 309 may also be configured to detect pressure changes, acoustic signals, etc. The duration of the wake/sleep cycle of the sensor 309 (or other downhole device) may be programmed prior to conveying the sensor 309 into the wellbore 212. This wake/sleep cycle may be set to a duration of days or weeks (i.e., until the sensor awakens again to obtain a measurement), although other durations are possible. The wake phase may last less than a second or multiple seconds depending on the task to be performed.

### Example Operations

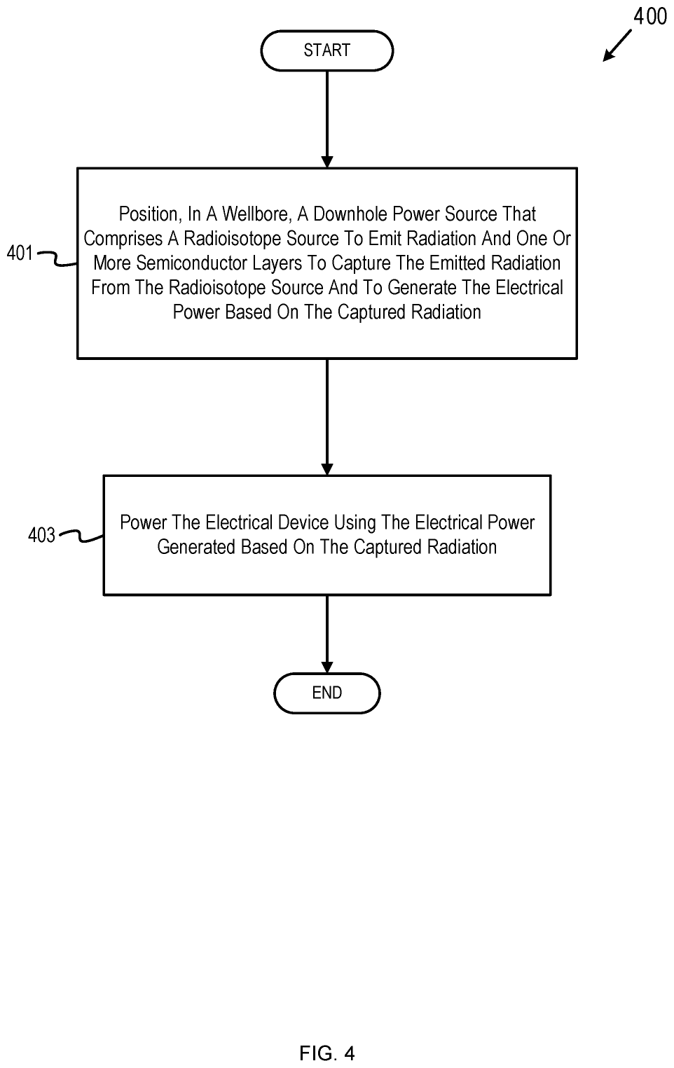

Example operations for powering downhole electrical devices using a non-thermal radio-voltaic power source are now described. FIG. 4 depicts a flowchart of example operations for powering downhole electrical devices, according to some embodiments. A method 400 describes the example operations for supplying electrical power to an electrical device in a wellbore. Operations of the method 400 begin at block 401.

At block 401, the method 400 comprises positioning, in a wellbore a downhole power source that comprises a radioisotope source to emit radiation and one or more semiconductor layers to capture the emitted radiation from the radioisotope source and to generate the electrical power based on the captured radiation. For example, with reference to FIGS. 1-2, a downhole power source comprising the radioisotope source 102 and the one or more semiconductor layers 104 may be positioned in the wellbore 212. The radioisotope source 102 may emit radiation such as beta particles which may induce an electrical current to generate electrical power upon capture by the one or more semiconductor layers 104. Flow progresses to block 403.

At block 403, the method 400 further comprises powering the electrical device using the electrical power generated based on the captured radiation. For example, with reference to FIG. 3, the captured radiation emitted from the radioisotope source 302 may induce a current used to provide power to the electrical circuit 329. The electrical circuit 329 may be coupled to a downhole device and may provide power to one or more of the downhole devices such as the sensor 309. Flow of the method 400 ceases.

While the aspects of the disclosure are described with reference to various implementations and exploitations, it will be understood that these aspects are illustrative and that the scope of the claims is not limited to them. In general, techniques for downhole power generation as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Example Embodiments

Embodiment #1: A downhole power source to be positioned in a wellbore to supply electrical power to an electrical device in the wellbore, the downhole power source comprising: a radioisotope source to be positioned downhole in the wellbore to emit radiation; and one or more semiconductor layers to be positioned downhole in the wellbore to capture the emitted radiation from the radioisotope source and to generate the electrical power based on the captured radiation.

Embodiment #2: The downhole power source of Embodiment 1, wherein the one or more semiconductor layers are to generate the electrical power independent of thermal emission from the radioisotope source.

Embodiment #3: The downhole power source of any one of Embodiments 1-2, wherein the one or more semiconductor layers are to be electrically coupled to the electrical device to be positioned in the wellbore to supply the electrical power from the one or more semiconductor layers to the electrical device.

Embodiment #4: The downhole power source of Embodiment 3, wherein the one or more semiconductor layers are to be electrically coupled to a power storage device to be positioned in the wellbore.

Embodiment #5: The downhole power source of Embodiment 4, wherein the power storage device comprises at least one of a capacitor, a battery, and a solenoid.

Embodiment #6: The downhole power source of any one of Embodiments 4-5, wherein the one or more semiconductor layers are electrically coupled to a power controller, wherein the power controller is configured to store the electrical power in the power storage device, and wherein the power controller is configured to control the power storage device such that the power storage device is to supply electrical power to the electrical device in response to a level of the electrical power stored in the power storage device exceeding a threshold of power to enable operation of the electrical device.

Embodiment #7: The downhole power source of any one of Embodiments 3-6, wherein the one or more semiconductor layers are electrically coupled to a power controller, wherein the power controller is electrically coupled to a different downhole power source that is to generate different electrical power that is greater than the electrical power generated based on the captured radiation, wherein the electrical device comprises a sensor to measure a property of a subsurface formation in which the wellbore is formed, and wherein the power controller is to control the different downhole power source to cause the different downhole power source to initiate generation of the different electrical power in response to the sensor measuring a value of the property of the subsurface formation that exceeds a property threshold.

Embodiment #8: A downhole system for use in a wellbore, the downhole system comprising: a radioisotope source to be positioned in the wellbore to emit radiation; and one or more semiconductor layers to be positioned in the wellbore to capture the emitted radiation from the radioisotope source and to generate electrical power based on the captured radiation; and an electrical device configured to be electrically coupled to the one or more semiconductor layers.

Embodiment #9: The downhole system of Embodiment 8, wherein the one or more semiconductor layers are to generate the electrical power independent of thermal emission from the radioisotope source.

Embodiment #10: The downhole system of any one of Embodiments 8-9, further comprising: a power storage device that is to be electrically coupled to the one or more semiconductor layers.

Embodiment #11: The downhole system of Embodiment 10, wherein the power storage device comprises at least one of a capacitor, a battery, and a solenoid.

Embodiment #12: The downhole system of any one of Embodiments 10-11, further comprising: a power controller configured to store the electrical power in the power storage device, and wherein the power controller is configured to control the power storage device such that the power storage device is to supply electrical power to the electrical device in response to a level of the electrical power stored in the power storage device exceeding a threshold of power to enable operation of the electrical device.

Embodiment #13: The downhole system of any one of Embodiments 8-12, wherein the electrical device comprises a sensor to measure a property of a subsurface formation in which the wellbore is formed, the downhole system further comprising: a different downhole power source that is to generate different electrical power that is greater than the electrical power generated based on the captured radiation; and a power controller to control the different downhole power source to cause the different downhole power source to initiate generation of the different electrical power in response to the sensor measuring a value of the property of the subsurface formation that exceeds a property threshold.

Embodiment #14: A method for supplying electrical power to an electrical device in a wellbore, the method comprising: positioning, in the wellbore, a downhole power source that comprises a radioisotope source to emit radiation and one or more semiconductor layers to capture the emitted radiation from the radioisotope source and to generate the electrical power based on the captured radiation; and powering the electrical device using the electrical power generated based on the captured radiation.

Embodiment #15: The method of Embodiment 14, wherein the one or more semiconductor layers are to generate the electrical power independent of thermal emission from the radioisotope source.

Embodiment #16: The method of any one of Embodiments 14-15, further comprising: storing the electrical power in a power storage device positioned in the wellbore.

Embodiment #17: The method of Embodiment 16, further comprising: determining a level of the electrical power stored in the power storage device, wherein powering the electrical device comprises, outputting the electrical power stored in the power storage device to the electrical device, in response to the level of the electrical power stored in the power storage device exceeding a threshold of power to enable operation of the electrical device.

Embodiment #18: The method of any one of Embodiments 16-17, wherein the electrical device comprises a sensor to measure a property of a subsurface formation in which the wellbore is formed.

Embodiment #19: The method of Embodiment 18, further comprising: measuring, using the sensor, a value of the property of the subsurface formation; and initiating generation of different electrical power from a different downhole power source in response to the value of the property exceeding a property threshold.

Embodiment #20: The method of Embodiment 19, wherein the different electrical power that is greater than the electrical power generated based on the captured radiation.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A downhole power source to be positioned in a wellbore to supply electrical power to an electrical device in the wellbore, the downhole power source comprising:
a radioisotope source to be positioned downhole in the wellbore to emit radiation; and
one or more semiconductor layers to be positioned downhole in the wellbore to capture the emitted radiation from the radioisotope source and to generate the electrical power based on the captured radiation.

2. The downhole power source of claim 1, wherein the one or more semiconductor layers are to generate the electrical power independent of thermal emission from the radioisotope source.

3. The downhole power source of claim 1, wherein the one or more semiconductor layers are to be electrically coupled to the electrical device to be positioned in the wellbore to supply the electrical power from the one or more semiconductor layers to the electrical device.

4. The downhole power source of claim 3, wherein the one or more semiconductor layers are to be electrically coupled to a power storage device to be positioned in the wellbore.

5. The downhole power source of claim 4, wherein the power storage device comprises at least one of a capacitor, a battery, and a solenoid.

6. The downhole power source of claim 4, wherein the one or more semiconductor layers are electrically coupled to a power controller, wherein the power controller is configured to store the electrical power in the power storage device, and wherein the power controller is configured to control the power storage device such that the power storage device is to supply electrical power to the electrical device in response to a level of the electrical power stored in the power storage device exceeding a threshold of power to enable operation of the electrical device.

7. The downhole power source of claim 3,
wherein the one or more semiconductor layers are electrically coupled to a power controller,
wherein the power controller is electrically coupled to a different downhole power source that is to generate different electrical power that is greater than the electrical power generated based on the captured radiation,
wherein the electrical device comprises a sensor to measure a property of a subsurface formation in which the wellbore is formed, and
wherein the power controller is to control the different downhole power source to cause the different downhole power source to initiate generation of the different electrical power in response to the sensor measuring a value of the property of the subsurface formation that exceeds a property threshold.

8. A downhole system for use in a wellbore, the downhole system comprising:
a radioisotope source to be positioned in the wellbore to emit radiation; and
one or more semiconductor layers to be positioned in the wellbore to capture the emitted radiation from the radioisotope source and to generate electrical power based on the captured radiation; and
an electrical device configured to be electrically coupled to the one or more semiconductor layers.

9. The downhole system of claim 8, wherein the one or more semiconductor layers are to generate the electrical power independent of thermal emission from the radioisotope source.

10. The downhole system of claim 8, further comprising:
a power storage device that is to be electrically coupled to the one or more semiconductor layers.

11. The downhole system of claim 10, wherein the power storage device comprises at least one of a capacitor, a battery, and a solenoid.

12. The downhole system of claim 10, further comprising:
a power controller configured to store the electrical power in the power storage device, and wherein the power controller is configured to control the power storage device such that the power storage device is to supply electrical power to the electrical device in response to a level of the electrical power stored in the power storage device exceeding a threshold of power to enable operation of the electrical device.

13. The downhole system of claim 8, wherein the electrical device comprises a sensor to measure a property of a subsurface formation in which the wellbore is formed, the downhole system further comprising:
a different downhole power source that is to generate different electrical power that is greater than the electrical power generated based on the captured radiation; and
a power controller to control the different downhole power source to cause the different downhole power source to initiate generation of the different electrical power in response to the sensor measuring a value of the property of the subsurface formation that exceeds a property threshold.

14. A method for supplying electrical power to an electrical device in a wellbore, the method comprising:
positioning, in the wellbore, a downhole power source that comprises a radioisotope source to emit radiation and one or more semiconductor layers to capture the emitted radiation from the radioisotope source and to generate the electrical power based on the captured radiation; and
powering the electrical device using the electrical power generated based on the captured radiation.

15. The method of claim 14, wherein the one or more semiconductor layers are to generate the electrical power independent of thermal emission from the radioisotope source.

16. The method of claim 14, further comprising:
storing the electrical power in a power storage device positioned in the wellbore.

17. The method of claim 16, further comprising:
determining a level of the electrical power stored in the power storage device,
wherein powering the electrical device comprises,
outputting the electrical power stored in the power storage device to the electrical device, in response to the level of the electrical power stored in the power storage device exceeding a threshold of power to enable operation of the electrical device.

18. The method of claim 16, wherein the electrical device comprises a sensor to measure a property of a subsurface formation in which the wellbore is formed.

19. The method of claim 18, further comprising:
measuring, using the sensor, a value of the property of the subsurface formation; and
initiating generation of different electrical power from a different downhole power source in response to the value of the property exceeding a property threshold.

20. The method of claim 19, wherein the different electrical power that is greater than the electrical power generated based on the captured radiation.
